(19) United States
(12) Patent Application Publication
(10) Pub. No.: US 2021/0020895 A1
(43) Pub. Date: Jan. 21, 2021

(54) SECONDARY BATTERY AND MANUFACTURING METHOD THEREOF

(71) Applicant: HONDA MOTOR CO., LTD., Tokyo (JP)

(72) Inventors: Masahiro Ohta, Wako-shi (JP); Wataru Shimizu, Wako-shi (JP); Toru Sukigara, Wako-shi (JP)

(21) Appl. No.: 16/929,157

(22) Filed: Jul. 15, 2020

(30) Foreign Application Priority Data
Jul. 19, 2019 (JP) 2019-133807

(51) Int. Cl. H01M 2/26; H01M 10/04

(52) U.S. Cl. CPC H01M 2/266; H01M 2220/30; H01M 10/0436

(57) ABSTRACT

A secondary battery (100) of the present invention includes: a laminate (101) formed by alternately laminating a positive electrode and a negative electrode via an electrolyte; on one sidewall (101a) side of the laminate, a positive electrode reinforcing member (102) attached to an end portion of a plate-shaped positive electrode collector which constitutes the positive electrode, and a positive electrode tab (103) which covers one sidewall (101a) surface of the laminate and is attached to an end portion of the positive electrode reinforcing member (102); on the other sidewall (101b) side of the laminate, a negative electrode reinforcing member (104) attached to an end portion of a plate-shaped negative electrode collector which constitutes the negative electrode, and a negative electrode tab (105) which covers the other sidewall (101b) surface of the laminate and is attached to an end portion of the negative electrode reinforcing member (104); and an outer package which encloses the laminate (101), the positive electrode reinforcing member (102), the positive electrode tab (103), the negative electrode reinforcing member (104), and the negative electrode tab (105).

### BACKGROUND OF THE INVENTION

### Field of the Invention

The present invention relates to a secondary battery and a manufacturing method thereof.

Priority is claimed on Japanese Patent Application No. 2019-133807, filed Jul. 19, 2019, the content of which is incorporated herein by reference.

### Description of Related Art

A secondary battery such as a lithium ion battery can be repeatedly charged and discharged and has a high energy density, and thus is applied in various technical fields such as those of small portable devices and electric vehicles. Ions are exchanged between a positive electrode and a negative electrode via an electrolyte in a secondary battery, and since an electrolyte of secondary batteries that have been widely used so far is a liquid, it is necessary to develop a configuration in which leakage of a liquid is prevented and thus there is a problem that a degree of freedom in design is restricted. In consideration of this problem, in recent years, attention has been paid to an all-solid-state battery whose electrolyte is a solid material.

An all-solid-state battery has both a higher energy density and safety than a secondary battery using a liquid electrolyte and practical applications there are expected soon. An all-solid-state battery is obtained by alternately laminating positive electrodes and negative electrodes that have been cut into desired shapes from positive electrode sheets and negative electrode sheets, in which electrode mixtures are applied to both surfaces of current-collecting foils for respective positive and negative electrodes and solid electrolytes are placed on upper surfaces of the electrode mixtures, and the laminate is finally press-molded (Patent Document 1).

### Patent Documents

[Patent Document 1] Japanese Unexamined Patent Application, First Publication No. 2015-118870

[Patent Document 2] Japanese Patent No. 5354646

### SUMMARY OF THE INVENTION

With recent reduction in size and thickness of electronic devices, there is a demand for further improvement in energy density of secondary batteries mounted in electronic devices. Attachment (joining) of a laminate constituting a secondary battery to tabs is performed by collecting end portions of a plurality of current-collecting bodies at positions of the tabs, and thus it is necessary to bend the end portions of the current-collecting bodies and provide a space for that (Patent Document 2). Presence of this space is one factor that reduces an energy density of a secondary battery.

The present invention has been made in view of the above circumstances, and an object of the present invention is to provide a secondary battery having an improved energy density.

In order to solve the above problems, the present invention employs the following means.

(1) A secondary battery according to one embodiment of the present invention includes a laminate formed by alternately laminating a positive electrode and a negative electrode via an electrolyte; on one sidewall side of the laminate, a positive electrode reinforcing member attached to an end portion of a plate-shaped positive electrode collector which constitutes the positive electrode, and a positive electrode tab which covers the one sidewall of the laminate and is attached to an end portion of the positive electrode reinforcing member; on the other sidewall side of the laminate, a negative electrode reinforcing member attached to an end portion of a plate-shaped negative electrode collector which constitutes the negative electrode, and a negative electrode tab which covers the other sidewall of the laminate and is attached to an end portion of the negative electrode reinforcing member; and an outer package which encloses the laminate, the positive electrode reinforcing member, the positive electrode tab, the negative electrode reinforcing member, and the negative electrode tab.

(2) In the secondary battery according to the above (1), the laminate may be wound multiple times around an axis connecting the positive electrode tab and the negative electrode tab, a plurality of attachment positions of the positive electrode reinforcing member with respect to the positive electrode tab may be separated from each other, and a plurality of attachment positions of the negative electrode reinforcing member with respect to the negative electrode tab may be separated from each other.

(3) In the secondary battery according to the above (1), the laminate may include a plurality of positive electrodes and a plurality of negative electrodes, a plurality of attachment positions of the positive electrode reinforcing member with respect to the positive electrode tab may be separated from each other, and a plurality of attachment positions of the negative electrode reinforcing member with respect to the negative electrode tab may be separated from each other.

(4) In the secondary battery according to any one of the above (1) to (3), the positive electrode tab may have a positive electrode flat portion which joins the positive electrode reinforcing member to one main surface thereof, and a positive electrode protruding portion which protrudes from the other main surface of the positive electrode flat portion, and the negative electrode tab may have a negative electrode flat portion which joins the negative electrode reinforcing member to one main surface thereof, and a negative electrode protruding portion which protrudes from the other main surface of the negative electrode flat portion.

(5) In the secondary battery according to any one of the above (1) to (4), an angle formed by the main surface of the positive electrode collector and the main surface of the positive electrode tab and an angle formed by the main surface of the negative electrode collector and the main surface of the negative electrode tab is preferably 85 degrees or more and 95 degrees or less, respectively.

(6) In the secondary battery according to any one of the above (1) to (5), central positions of a plurality of the positive electrode reinforcing members and a plurality of the negative electrode reinforcing members, which are arranged in a laminating direction of the laminate, may be separated from a center line connecting centers of the positive electrode tab and the negative electrode tab, a size of distances between the center line and the central position of the positive electrode reinforcing member monotonically increase or decrease in accordance with the order of arrangement in the laminating direction, and a size of distances between the center line and the central position of the negative electrode reinforcing member monotonically increase or decrease in accordance with the order of arrangement in the laminating direction.

(7) In the secondary battery according to any one of the above (1) to (5), a plurality of the positive electrode reinforcing members and a plurality of the negative electrode reinforcing members may be arranged in the laminating direction of the laminate, and lengths of the plurality of positive electrode reinforcing members and lengths of the plurality of negative electrode reinforcing members in a direction orthogonal to the center line connecting the centers of the positive electrode tab and the negative electrode tab may monotonically increase or decrease in accordance with the order of arrangement in the laminating direction.

(8) In the secondary battery according to any one of the above (1) to (7), the electrolyte may be a solid.

(9) In the secondary battery according to any one of the above (1) to (7), the electrolyte may be a liquid.

(10) A manufacturing method of a secondary battery according to one aspect of the present invention is a manufacturing method of the secondary battery according to any one of the above (8) or (9), which includes processes of: attaching the positive electrode reinforcing member and the negative electrode reinforcing member to the positive electrode collector and the negative electrode collector, respectively; and attaching the positive electrode tab and the negative electrode tab to the positive electrode collector to which the positive electrode reinforcing member is attached and the negative electrode collector to which the negative electrode reinforcing member is attached, respectively.

In the secondary battery of the present invention, a plurality of end portions of the current-collecting bodies are individually attached to the tabs without being bundled together. Therefore, in the secondary battery of the present invention, the volume can be reduced because there is no space for bundling the end portions of the current-collecting bodies, so that the energy density thereof can be increased.

### BRIEF DESCRIPTION OF THE DRAWINGS

FIG. 1A is a perspective view of a secondary battery according to a first embodiment of the present invention.

FIG. 1B is a plan view of the secondary battery according to the first embodiment of the present invention.

FIG. 2A is a cross-sectional view of the secondary battery in FIG. 1.

FIG. 2B is a cross-sectional view of the secondary battery in FIG. 1.

FIG. 3A is an enlarged view of a part of the secondary battery in FIG. 2B.

FIG. 3B is an enlarged view of a part of the secondary battery in FIG. 2B.

FIG. 4A is a perspective view of a positive electrode sheet that constitutes the secondary battery in FIG. 1.

FIG. 4B is a perspective view of a first solid electrolyte sheet that constitutes the secondary battery in FIG. 1.

FIG. 4C is a perspective view of a negative electrode sheet that constitutes the secondary battery in FIG. 1.

FIG. 4D is a perspective view of a second solid electrolyte sheet that constitutes the secondary battery in FIG. 1.

FIG. 5A is a perspective view of a secondary battery according to a second embodiment of the present invention.

FIG. 5B is a plan view of the secondary battery according to the second embodiment of the present invention.

FIG. 6 is a cross-sectional view of the secondary battery in FIG. 5.

FIG. 7A is a plan view of a positive electrode sheet that constitutes the secondary battery in FIG. 5.

FIG. 7B is a plan view of a negative electrode sheet that constitutes the secondary battery in FIG. 5.

FIG. 8A is a perspective view of a secondary battery according to a third embodiment of the present invention.

FIG. 8B is a plan view of the secondary battery according to the third embodiment of the present invention.

FIG. 9A is a plan view of a positive electrode sheet constituting the secondary battery in FIGS. 8A and 8B.

FIG. 9B is a plan view of a negative electrode sheet constituting the secondary battery in FIGS. 8A and 8B.

### DETAILED DESCRIPTION OF THE INVENTION

Hereinafter, a secondary battery according to an embodiment to which the present invention is applied and a manufacturing method thereof will be described in detail with reference to the drawings. Also, in the drawings used in the following description, in order to make features easy to understand, the features may be shown in an enlarged manner for convenience, and dimensional ratios of respective components may not necessarily be the same as actual ones. Further, materials, dimensions, and the like provided in the following description are exemplary examples, and the present invention is not limited thereto and can be appropriately modified and implemented without changing the gist of the present invention.

### First Embodiment

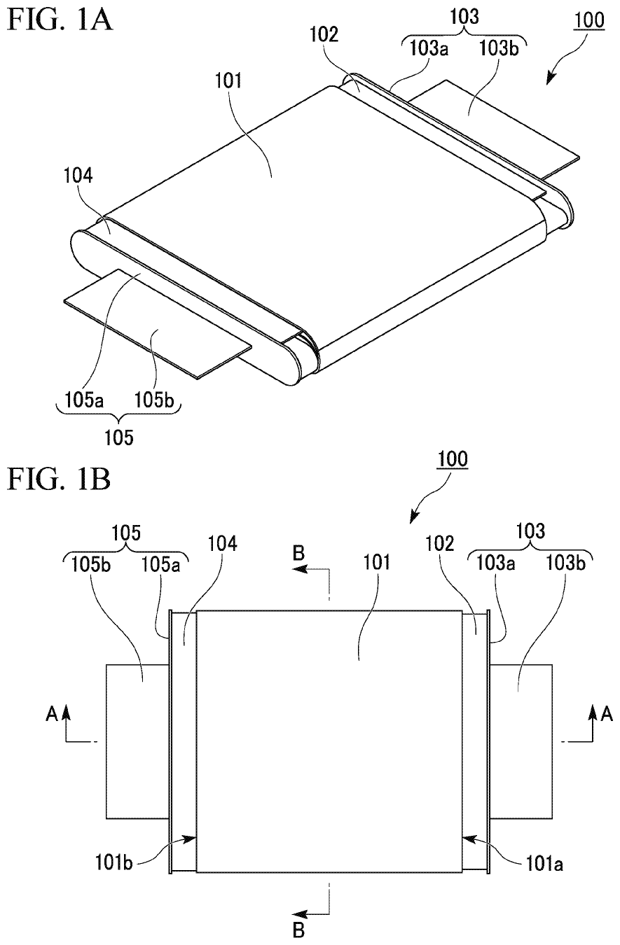

FIGS. 1A and 1B are a perspective view and a plan view of a secondary battery 100 according to a first embodiment of the present invention, respectively. The secondary battery 100 is mainly configured of a laminate 101 that functions as an element for performing charging and discharging, a positive electrode reinforcing member 102, a positive electrode tab 103, a negative electrode reinforcing member 104, a negative electrode tab 105, and an outer package (not shown) that encloses the laminate 101. An electrode structure thereof may be either a laminated type or a wound (winding) type, but the present embodiment exemplifies a case of the wound type.

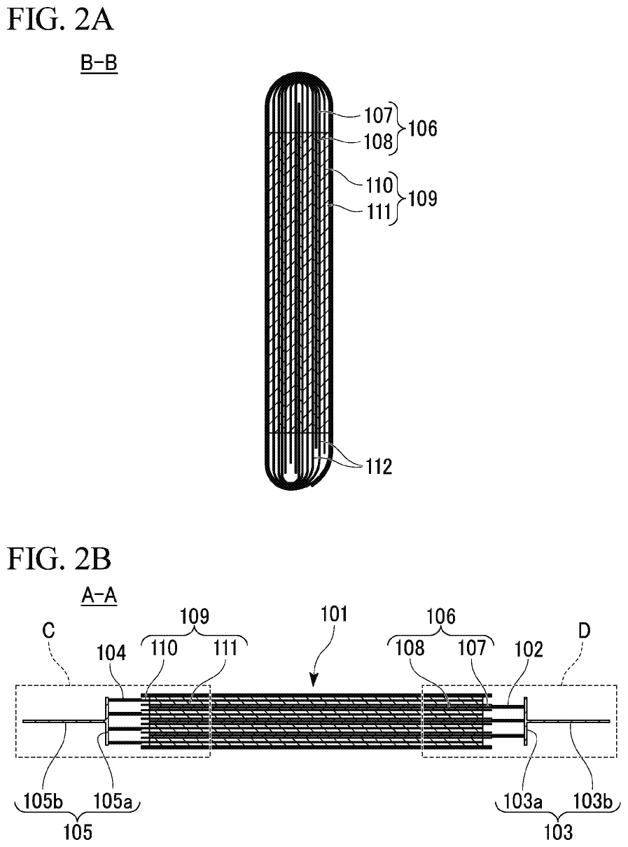

FIG. 2A is a cross-sectional view of the secondary battery 100 in FIG. 1B along a plane passing through line B-B. FIG. 2B is a cross-sectional view of the secondary battery 100 in FIG. 1B along a plane passing through line A-A. The laminate 101 is formed by alternately laminating positive electrodes 106 and negative electrodes 109 via an electrolyte. The number of laminations of the positive electrodes 106 and the negative electrodes 109 is not limited. The electrolyte may be a solid or a liquid. However, when the electrolyte is a liquid, it is necessary to sandwich separators 112 therebetween.

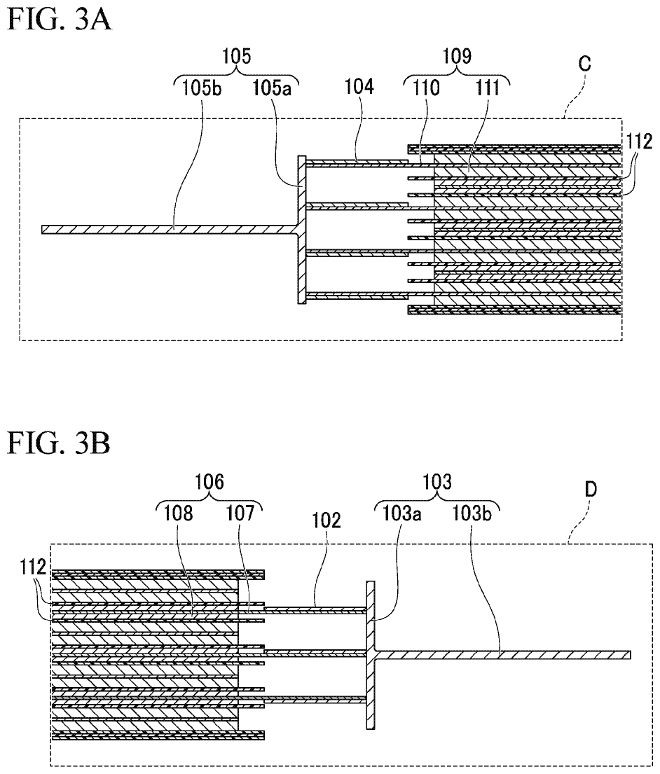

FIGS. 3A and 3B are enlarged views of a partial region C on a side from which the negative electrodes protrude and a partial region D on a side from which the positive electrodes protrude in the secondary battery 100 in FIG. 2B. The positive electrode 106 is mainly configured of a plate-shaped positive electrode collector (foil) 107 and positive electrode mixtures 108 formed on main surfaces thereof. Also, the negative electrode 109 is mainly configured of a plate-shaped negative electrode collector (foil) 110 and negative electrode mixtures 111 formed on main surfaces thereof. The positive electrode mixture 108 and the negative electrode mixture 111 include a positive electrode active material and a negative electrode active material, respectively, and may further include a binder, a conductivity aid, and an electrolyte as necessary.

Examples of a material of the positive electrode collector (current-collecting body) 107 include metal materials or the like such as SUS, Ni, Cr, Au, Pt, Al, Fe, Ti, Zn, or Cu. Further, examples of a form of the positive electrode collector include a foil shape, a plate shape, a mesh shape, a non-woven cloth form, and a foamed form. Carbon or the like may be disposed on a surface of the positive electrode collector in order to improve adhesiveness, or the surface may be roughened. For example, when the shape of the positive electrode collector 107 is a foil shape or a plate shape, a thickness thereof is preferably about 5 to 20 μm.

Examples of the negative electrode collector (current-collecting body) 110 include a material such as Cu, SUS, Ni, or Ti, and examples of a shape thereof include a foil shape, a plate shape, a mesh shape, a non-woven cloth form, and a foamed form. Further, carbon or the like may be disposed on a surface of the negative electrode collector in order to improve adhesiveness, or the surface may be roughened. A thickness of the negative electrode collector is not particularly limited and can be appropriately selected as necessary. For example, when the negative electrode collector 110 has a foil shape or a plate shape, the thickness is preferably about 5 to 20 μm.

For a material of the positive electrode active material, a known material such as a composite oxide containing a transition metal and lithium such as lithium cobalt oxide (LiCoO₂), lithium nickel oxide (LiNiO₂), lithium manganate (LiMnO₂), lithium manganese spinel (LiMn₂O₄), and olivine type lithium phosphorus oxide (LiFePO₄), a conductive polymer such as polyaniline or polypyrrole, a sulfide such as Li₂S, CuS, a Li—Cu—S compound, TiS₂, FeS, MoS₂, or a Li—Mo—S compound, a mixture of sulfur and carbon, etc., can be used. The positive electrode active material may be composed of one kind of the above materials or may be composed of two or more kinds thereof.

For a material of the negative electrode active material, a known material such as a metal element such as indium, aluminum, silicon, tin, lithium or an alloy thereof, an inorganic oxide (for example, Li₄Ti₅O₁₂) or the like, a carbon-based active material (for example, meso-carbon microbeads (MCMB), highly oriented graphite (HOPG), hard carbon, soft carbon, or the like), a conductive polymer such as polyacene, polyacetylene, or polypyrrole, etc., can be used. The negative electrode active material may be composed of one kind of the above materials or may be composed of two or more kinds thereof.

For the binder, a fluororesin such as polyvinylidene fluoride (PVDF), polytetrafluoroethylene (PTFE), tetrafluoroethylene-hexafluoropropylene copolymer (FEP), tetrafluoroethylene-perfluoroalkyl vinyl ether copolymer (PFA), ethylene-tetrafluoroethylene copolymer (ETFE), polychlorotrifluoroethylene (PCTFE), ethylene-chlorotrifluoroethylene copolymer (ECTFE), or polyvinyl fluoride (PVF), an acrylic acid polymer, a cellulose polymer, a styrene polymer, a styrene-butadiene copolymer, a vinyl acetate polymer, a urethane polymer, etc., can be used. The binder may be composed of one kind of the above materials or may be composed of two or more kinds thereof.

For the conductivity aid, a carbon powder such as carbon black, carbon nanotubes, carbon materials, fine metal powders such as those of copper, nickel, stainless steel, or iron, a mixture of a carbon material and fine metal powder, or a conductive oxide such as ITO can be used. The conductivity aid may be composed of one kind of the above materials or may be composed of two or more kinds thereof.

The positive electrode reinforcing member 102 having a thickness of about 5 μm to 300 μm is attached to the other surface of the surfaces of the positive electrode collector 107 on which the positive electrode mixture 108 is not formed. Also, the negative electrode reinforcing member 104 having a thickness of about 5 μm to 300 μm is attached to the other surface of the surfaces of the negative electrode collector 110 on which the negative electrode mixture 111 is not formed. Materials of the positive electrode reinforcing member 102 and the negative electrode reinforcing member 104 are preferably the same as those of the positive electrode collector 107 and the negative electrode collector 110, respectively, in order to prevent electrolytic corrosion (rusting).

The positive electrode tab 103 is attached to an end portion of the positive electrode collector 107, to which the positive electrode reinforcing member 102 is attached, on the protruding side (a side connected to an external wiring). Further, the negative electrode tab 105 is attached to an end portion of the negative electrode collector 110 to which the negative electrode reinforcing member 104 is attached. As the positive electrode tab 103, one mainly shown in FIG. 3B which has a positive electrode flat portion 103a for joining the positive electrode reinforcing member 102 to one main surface thereof, and a positive electrode protruding portion 103b that protrudes from the other main surface of the positive electrode flat portion 103a is an exemplary example. Similarly, as the negative electrode tab 105, one mainly shown in FIG. 3A which has a negative electrode flat portion 105a for joining the negative electrode reinforcing member 104 to one main surface thereof, and a negative electrode protruding portion 105b that protrudes from the other main surface of the negative electrode flat portion 105a is an exemplary example.

The positive electrode flat portion 103a is attached to end portions of a plurality of positive electrode current-collecting bodies 107 to which the positive electrode reinforcing members 102 are attached and covers one sidewall 101a side of the laminate including these end portions. The positive electrode protruding portion 103b protrudes from the positive electrode flat portion 103a to be connected to a predetermined external terminal (not shown). In addition, the negative electrode flat portion 105a is attached to end portions of a plurality of negative electrode current-collecting bodies 110 to which the negative electrode reinforcing members 104 are attached and covers the other sidewall 101b side of the laminate including these end portions. The negative electrode protruding portion 105b protrudes from the negative electrode flat portion 105a to be connected to a predetermined external terminal (not shown).

A method for attaching the positive electrode collector 107 and the positive electrode reinforcing member 102 to the positive electrode tab 103 and a method for attaching the negative electrode collector 110 and the negative electrode reinforcing member 104 to the negative electrode tab 105 are not particularly limited. As an appropriate method, for example, a method of welding both end surfaces to be attached by irradiation of ultrasonic waves or a laser beam, a method of caulking the end surfaces, a method of plating a material of the positive electrode tab 112, and so on, is an exemplary example. Also, it may be undesirable to attach them with an adhesive from a viewpoint of maintaining conductivity. The positive electrode collector 107 and the negative electrode collector 110 are thin, and thus, when welding and caulking are performed without attaching the positive electrode reinforcing member 102 and the negative electrode reinforcing member 104 to the positive electrode collector 107 and the negative electrode collector 110, respectively, the positive electrode collector 107 and the negative electrode collector 110 themselves may be melted or damaged.

The end portions of the positive electrode current-collecting bodies 107 and the negative electrode current-collecting bodies 110 on the respective protruding sides are attached to the positive electrode tab 103 and the negative electrode tab 105, respectively, in a state in which they are not bundled together. That is, a plurality of attachment positions (welding positions, caulking positions, or the like) of the positive electrode current-collecting bodies 107, to which the positive electrode reinforcing members 102 are attached, with respect to the positive electrode tab 103 are separated from each other. Similarly, a plurality of attachment positions (welding position, caulking position, or the like) of the negative electrode current-collecting bodies 110, to which the negative electrode reinforcing members 104 are attached, with respect to the negative electrode tab 105 are also separated from each other. Since it is not necessary to provide spaces for bundling the end portions of the positive electrode current-collecting bodies 107 and the negative electrode current-collecting bodies 110, a distance between the laminate 101 and the positive electrode tab 103 and the distance between the laminate 101 and the negative electrode tab 105 can be shortened to a minimum.

As a result, all of the end portions of the positive electrode current-collecting bodies 107 and the negative electrode current-collecting bodies 110 are in a state in which they are not bent (a flat plate state), similarly to central portions thereof. An angle formed by the main surface of the positive electrode collector 107 and the main surface of the positive electrode flat portion 103a of the positive electrode tab and an angle formed by the main surface of the negative electrode collector 110 and the main surface of the negative electrode flat portion 105a of the negative electrode tab respectively are preferably 85 degrees or more and 95 degrees or less, and more preferably 90 degrees.

As shown in FIG. 3B, the positive electrode reinforcing member 102 is attached to the surface of the positive electrode collector 107 only in the vicinity of the end portion on the positive electrode tab 103 side. Also, as shown in FIG. 3A, the negative electrode reinforcing member 104 is attached on the surface of the negative electrode collector 110 only in the vicinity of the end portion on the negative electrode tab 105 side. From a viewpoint of increasing energy density, it is preferable to narrow attachment regions thereof. As shown in FIGS. 3A and 3B, the attachment regions are limited only to the vicinities of the end portions on the positive electrode tab 103 side and the negative electrode tab 105 side so that volumes thereof can be reduced, and thus an energy density of the secondary battery 100 can be increased.

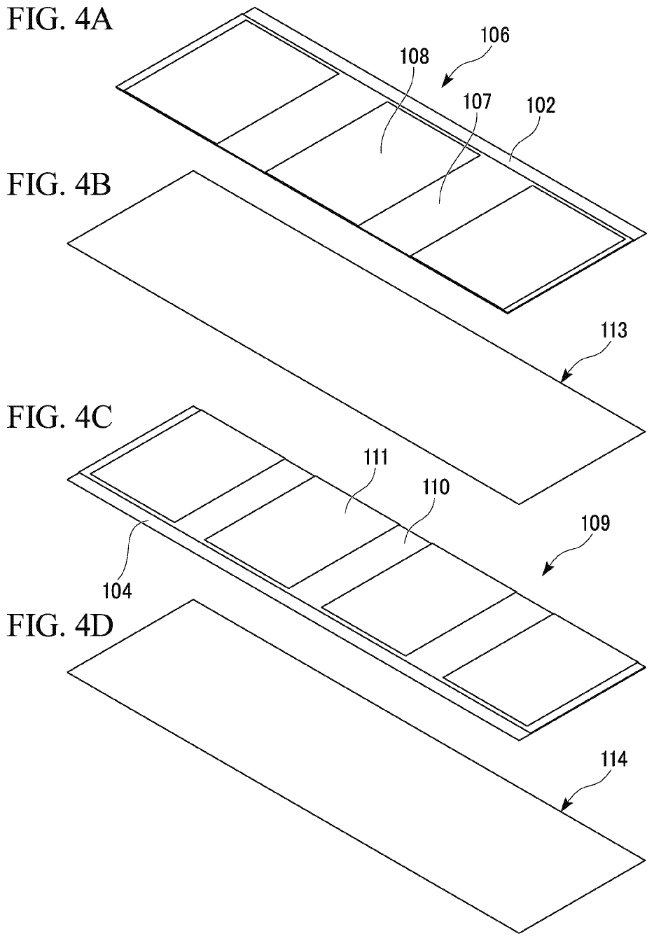

FIGS. 4A to 4D are perspective views of a positive electrode sheet, a first solid electrolyte sheet, a negative electrode sheet, and a second solid electrolyte sheet, respectively, which constitute the laminate 101. In the present embodiment, the laminate formed by sequentially laminating a layer of the positive electrode 106 as shown in FIG. 4A (positive electrode sheet 106), the first solid electrolyte sheet 113 as shown in FIG. 4B, a layer of the negative electrode 109 as shown in FIG. 4C (negative electrode sheet 109), the second solid electrolyte sheet 114 as shown in FIG. 4D is wound around an axis (not shown) connecting the positive electrode tab 103 and the negative electrode tab 105. In this way, in a case in which the positive electrode 106 and the negative electrode 109 constituting the laminate are each one layer, at least one place on the positive electrode reinforcing member 107 may be joined to the positive electrode tab 103, and at least one place on the negative electrode reinforcing member 104 may be joined to the negative electrode tab 105. For example, a place for attaching the positive electrode reinforcing member 102 may be only an outermost peripheral portion of the positive electrode collector 107. Similarly, a place for attaching the negative electrode reinforcing member 104 may be only an outermost peripheral portion of the negative electrode collector 110. In this case, joining between the positive electrode reinforcing member and the positive electrode tab and joining between the negative electrode reinforcing member and the negative electrode tab can be easily performed.

In each of the positive electrode 106 and the negative electrode 109, when the thickness of each collector is compared with a thickness of the tab, the thickness of the tab is thicker, and thus, if the connection is attempted by welding or the like, only the collector is melted, and the connection between the collector and the tab cannot be performed. For this reason, the connection between the collector and the tab is performed using an electrode reinforcing member (the positive electrode reinforcing member 102, and the negative electrode reinforcing member 104) that is thicker than the collector and thinner than the tab and is performed in a procedure of first welding the collector and the reinforcing member and then welding the reinforcing member and the tab.

A performance of the secondary battery 100 can be improved by changing sizes of the positive electrode reinforcing member 102 and the negative electrode reinforcing member 104 to be attached. For example, as the thicknesses and volumes of the positive electrode reinforcing member 102 and the negative electrode reinforcing member 104 to be attached are reduced, an energy density of the secondary battery 100 can be improved, and on the contrary, as they are increased, attachment strengths thereof with respect to the positive electrode tab 103 and the negative electrode tab 105 can be increased.

A material of the electrolyte may be one having a low electron conductivity and a high lithium ion conductivity. The electrolyte of the present embodiment may be a solid or a liquid.

The solid electrolyte may be any one capable of conducting lithium ions, and for example, at least one selected from the group consisting of perovskite type compounds such as La_{0.51}Li_{0.34}TiO_{2.94} and La_{0.5}Li_{0.5}TiO₃, LISICON-type compounds such as Li₁₄Zn(GeO₄)₄, garnet type compounds such as Li₇La₃Zr₂O₁₂, NASICON type compounds such as Li_{1.3}Al_{0.3}Ti_{1.7}(PO₄)₃ and Li_{1.5}Al_{0.5}Ge_{1.5}(PO₄)₃, thio-LISICON type compounds such as Li_{3.25}Ge_{0.25}P_{0.75}S₄ and Li₃PS₄, glass compounds such as 50Li₄SiO₄.₅₀Li₃BO₃, Li₂S—P₂S₅ and Li₂O—Li₃O₅—SiO₂, phosphoric acid compounds such as Li₃PO₄, Li_{3.5}Si_{0.5}P_{0.5}O₄ and Li_{2.9}PO_{3.3}N_{0.46}, amorphous compounds such as Li_{2.9}PO_{3.3}N_{0.46} (LIPON) and Li_{3.6}Si_{0.6}P_{0.4}O₄, glass ceramics such as Li_{1.07}Al_{0.69}Ti_{1.46}(PO₄)₃ and Li_{1.5}Al_{0.5}Ge_{1.5}(PO₄)₃, an inorganic solid electrolyte such as lithium-containing salts, a polymer-based solid electrolyte such as polyethylene oxide, a gel-based solid electrolyte containing lithium-containing salts and ionic liquids with lithium ion conductivity, etc., can be used.

As the liquid electrolyte (non-aqueous electrolyte), a salt containing a cation and an anion, in which, for example, the cation is lithium, tetraethylammonium, triethylmethylammonium, quaternary ammonium such as spiro-(1,1′)-bipyrrolidinium or diethylmethyl-2-methoxyethylammonium (DEME), or imidazolium such as 1,3-dialkylimidazolium, 1,2,3-trialkylimidazolium, 1-ethyl-3-methylimidazolium (EMI) or 1,2-dimethyl-3-propylimidazolium (DMPI), and the anion is BF₄⁻, PF₆⁻, ClO₄⁻, AlCl₄⁻ or CF₃SO₃⁻, an ionic liquid such as LiTFSi, and so on, can be used. One of these may be used alone or a combination of two or more of these may be used in an arbitrary ratio.

Examples of these solvents include organic solvents such as propylene carbonate (PC), ethylene carbonate (EC), dimethyl carbonate (DMC), diethyl carbonate (DEC), acetonitrile (AN), propionitrile, γ-butyrolactone (BL), dimethylformamide (DMF), tetrahydrofuran (THF), dimethoxyethane (DME), dimethoxymethane (DMM), sulfolane (SL), dimethyl sulfoxide (DMSO), ethylene glycol, propylene glycol, methyl cellosolve, etc. One of these may be used alone or a combination of two or more of these may be used in an arbitrary ratio.

The secondary battery 100 having a solid electrolyte can be manufactured by the following procedure. First, materials of a positive electrode active material, a solid electrolyte, a binder, and a conductivity aid are mixed at a predetermined ratio to prepare a slurry that is a raw material of the positive electrode mixture 108. Subsequently, the slurry is applied to the positive electrode collector 107 using a roll coating method, a die coating method, a gravure coating method, a spin coating method, a dip method, a screen printing method, or the like. Subsequently, the positive electrode collector 107 coated with the slurry is dried in a high temperature environment to remove a solvent in the slurry, and the positive electrode 106 in which a layer of the positive electrode mixture 108 is formed on the positive electrode collector 107 is obtained. Further, materials of a negative electrode active material, a solid electrolyte, a binder, and a conductivity aid are mixed at a predetermined ratio to prepare a slurry as a raw material of the negative electrode mixture 111, and the slurry is applied and dried to obtain the negative electrode 109 in which a layer of the negative electrode mixture 111 is formed on the negative electrode collector 110, similar to the case of manufacturing the positive electrode 106.

Next, the positive electrode reinforcing member 102 and the negative electrode reinforcing member 104 are attached to the end portions of the positive electrode collector 107 and the negative electrode collector 110 on the protruding sides, respectively. In the secondary battery 100 of the present embodiment, since the end portions of the current-collecting bodies are not bent, damage such as cleavage of the end portions of the current-collecting bodies due to a pressure at the time of attaching the reinforcing members can be avoided. Also, the positive electrode reinforcing member 102 and the negative electrode reinforcing member 104 may be attached before the slurry is applied to each collector.

Next, a solid electrolyte slurry made of a solid electrolyte, a binder, and a solvent is prepared, coated on a porous substrate such as a non-woven fabric, and densified by roll pressing or the like after the solvent contained in the solid electrolyte slurry is removed, whereby a solid electrolyte sheet is prepared. Subsequently, a negative electrode sheet, the solid electrolyte sheet, a positive electrode sheet, and the solid electrolyte sheet are superimposed in this order and wound from one end thereof to form a wound body, and then the wound body is pressed from both sides in a thickness direction (superimposing direction) thereof to obtain the laminate 101. The positive electrode reinforcing member 102 and the positive electrode tab 103 are electrically connected to the positive electrode collector 107 of the laminate 101, the negative electrode reinforcing member 104 and the negative electrode tab 105 are electrically connected to the negative electrode collector 110, and the resultant is accommodated and sealed in an outer package (not shown), whereby the secondary battery 100 can be obtained.

The solid electrolyte can also be prepared by applying a slurry containing a material of the solid electrolyte to at least one of the positive electrode 106 and the negative electrode 109 and drying and removing the solvent in the slurry without using the solid electrolyte sheets separate from the positive electrode 106 and the negative electrode 109,

The secondary battery 100 having a liquid electrolyte can be manufactured by the following procedure. First, a positive electrode is formed by applying a slurry obtained by mixing the materials of a positive electrode active material, a binder, and a conductivity aid at a predetermined ratio to the positive electrode collector 107 and drying the slurry. Further, a negative electrode is formed by applying a slurry prepared by mixing the materials of a negative electrode active material, a binder, and a conductivity aid at a predetermined ratio to the negative electrode collector 110 and drying the slurry. The separator 112 which is sandwiched between the positive electrode and the negative electrode which have been superimposed on each other, the laminate, in which the electrode reinforcing members and the electrode tabs are electrically connected to the positive electrode and the negative electrode, respectively, and a liquid electrolyte are accommodated and sealed in an outer package, whereby the secondary battery can be obtained. Similarly to the case of the secondary battery 100 having a solid electrolyte, the positive electrode mixture 108 and the negative electrode mixture 111 may contain the solid electrolyte.

As described above, in the secondary battery 100 according to the present embodiment, the plurality of end portions of the current-collecting bodies are individually attached to the tabs without being bundled together. Therefore, the secondary battery 100 of the present embodiment can be reduced in volume because no space for bundling the end portions of the current-collecting bodies is provided, so that an energy density thereof can be increased.

### Second Embodiment

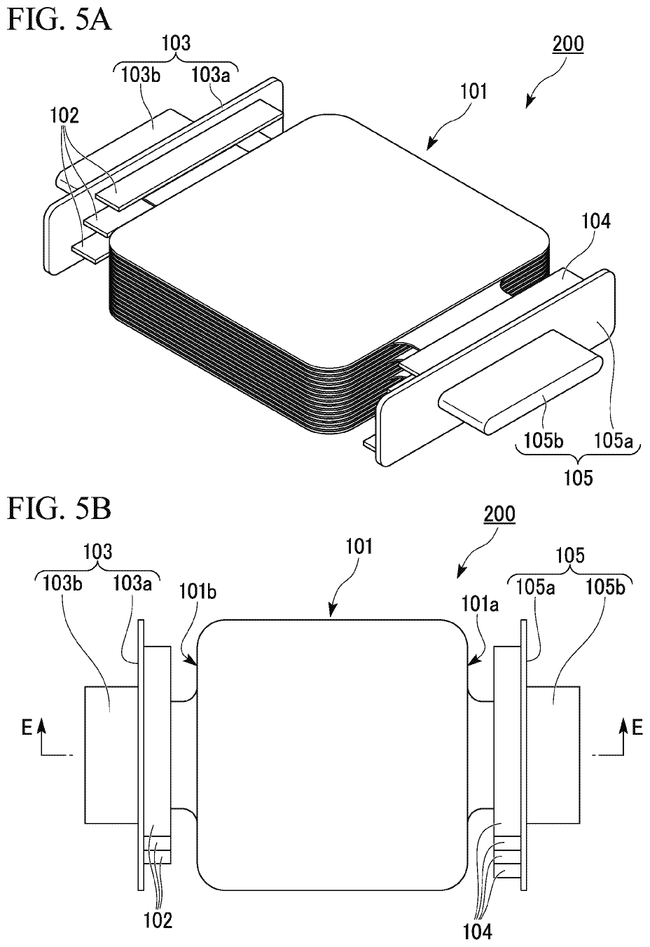

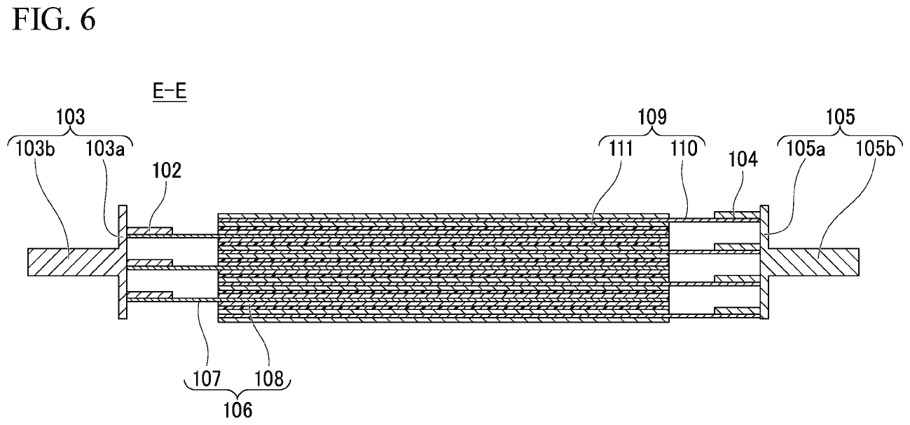

FIGS. 5A and 5B are respectively a perspective view and a plan view of a secondary battery 200 according to a second embodiment of the present invention. FIG. 6 is a cross-sectional view of the secondary battery 200 in FIG. 5B along a plane passing through line E-E. An electrode structure of the secondary battery 200 is a laminated type in which a positive electrode sheet (the positive electrode 106), a negative electrode sheet (the negative electrode 109), and a solid electrolyte sheet are processed into a predetermined shape, and the positive electrode sheet and the negative electrode sheet are alternately laminated a plurality of times with the solid electrolyte sheet interposed therebetween. Positive electrode reinforcing members 102 are joined to the positive electrode sheet, and negative electrode reinforcing members 104 are joined to the negative electrode sheet. Other configurations are the same as the configurations of the first embodiment, and portions corresponding to those of the first embodiment are denoted by the same reference numerals regardless of differences in shape. In the present embodiment, at least the same effects as those of the first embodiment can be obtained.

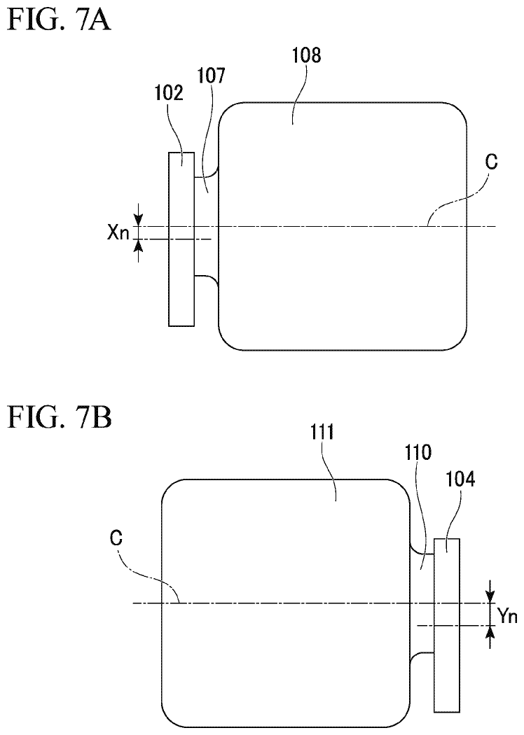

FIGS. 7A and 7B are plan views of the positive electrode sheet and the negative electrode sheet which constitute the laminate 101. Most of the positive electrode collector 107 is covered with the positive electrode mixture 108, and the positive electrode reinforcing member 102 is attached to an uncovered end portion thereof. In a plan view seen in a laminating direction of the laminate 101, a central position of the positive electrode reinforcing member 102 is deviated by a predetermined amount (Xn) from a center line C that divides areas of the positive electrode collector 107 and the positive electrode mixture 108 into two substantially equal parts. Also, in the same plane view, a central position of the negative electrode reinforcing member 104 is deviated by a predetermined amount (Yn) from the center line C that divides areas of the negative electrode collector 110 and the negative electrode mixture 111 into two substantially equal parts.

The amounts Xn and Yn of the deviation of the central positions increase or decrease as the layers change in the laminating direction. That is, the central positions of the plurality of positive electrode reinforcing members 102 and the plurality of negative electrode reinforcing members 104 arranged in the laminating direction of the laminate 101 are separated from the center line C connecting the centers of the positive electrode tab 103 and the negative electrode tab 105, respectively, and sizes of distances between the respective central positions monotonically increase or decrease in accordance with the order of arrangement in the laminating direction. Therefore, positions of the end portions of the positive electrode reinforcing members 102 and the negative electrode reinforcing members 104 also deviate as the layers change, and as a result, a staircase structure as shown in FIG. 5B is formed. For that reason, the positive electrode reinforcing member 102 and the negative electrode reinforcing member 104 attached to the current-collecting bodies of any layer have exposed portions in a plan view seen in the laminating direction, that is, weldable portions.

In general, it is difficult to radiate a laser beam from a surface to a deep part of a member. However, in the above configuration, deviations of the positive electrode reinforcing member 102 and the negative electrode reinforcing member 104 increase from an upper laminate surface (or a lower laminate surface) toward the lower laminate surface (or the upper laminate surface), and the positive electrode collector of any layer has a portion that does not overlap with the positive electrode collector of the layer immediately above when viewed from the vertical direction. Accordingly, a laser beam can be radiated in a vertical direction, and thus all current-collecting bodies can be welded to the tab.

Also in the secondary battery 200 according to the present embodiment, the plurality of end portions of the current-collecting bodies are individually attached to the tabs without being bundled together. Therefore, also in the secondary battery 200 of the present embodiment, the volume can be reduced because there is no space for bundling the end portions of the collector, and thus the energy density thereof can be increased.

### Third Embodiment

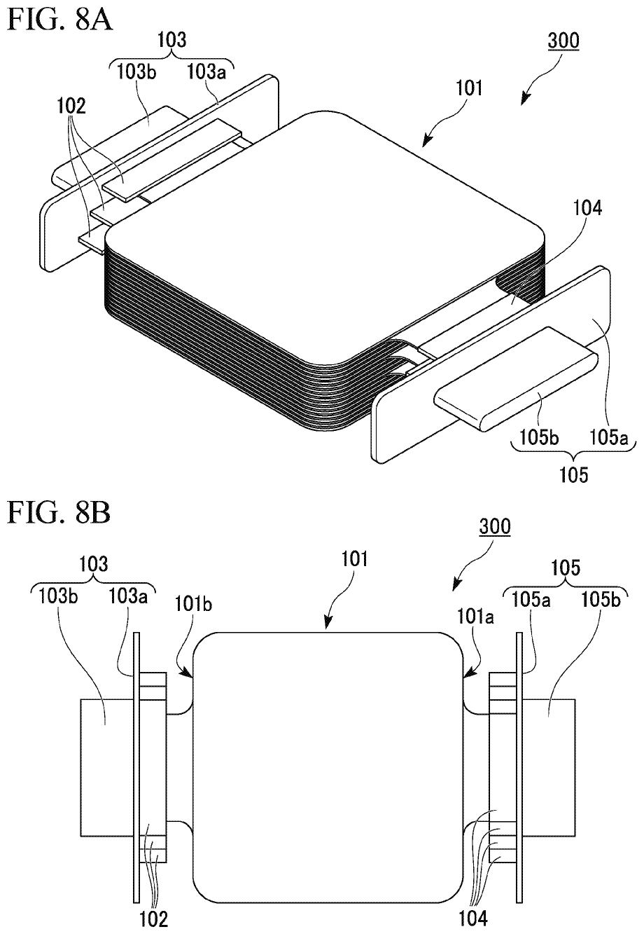

FIGS. 8A and 8B are respectively a perspective view and a plan view of a secondary battery 300 according to a third embodiment of the present invention. An electrode structure of the secondary battery 300 is a laminated type similar to that of the second embodiment, but configurations of the positive electrode reinforcing member 102 and the negative electrode reinforcing member 104 are different therefrom. Parts corresponding to those in the second embodiment are denoted by the same reference numerals regardless of differences in shape. In the present embodiment, at least the same effects as those of the second embodiment can be obtained.

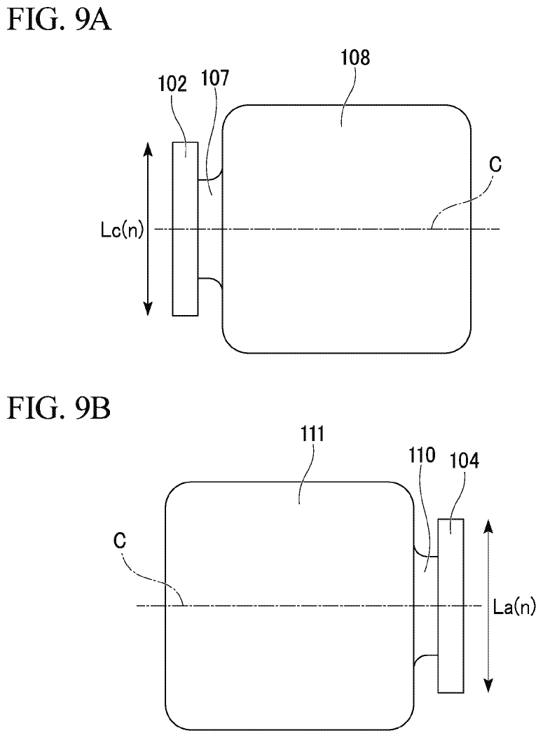

FIG. 9A is a plan view of a positive electrode sheet constituting the laminate 101. A plurality of positive electrode reinforcing members 102 are arranged in the laminating direction of the laminate 101. The plurality of positive electrode reinforcing members 102 are attached such that their respective central positions are disposed on the center line C (on center line C connecting centers of the positive electrode tab 103 and the negative electrode tab 105) of the positive electrode collector 107. In a direction orthogonal to the center line C, lengths of the plurality of positive electrode reinforcing members 102 monotonically increase or decrease in accordance with the order of arrangement in the laminating direction.

In FIG. 9A, in a case in which the number of laminations of the positive electrode sheets is n, a length of the positive electrode reinforcing member 102 in the direction orthogonal to the center line C, which is a n-th laminated layer from one end side thereof in the laminating direction is represented as Lc(n). The positive electrode reinforcing member 102 of the present embodiment is configured such that the length Lc(n) monotonically increases or decreases from one end side to the other end side in the laminating direction.

FIG. 9B is a plan view of the negative electrode sheet which constitutes the laminate 101. A plurality of negative electrode reinforcing members 104 are arranged in the laminating direction of the laminate 101. The plurality of negative electrode reinforcing members 104 are attached such that the respective central positions are disposed on the center line C (on the center line C connecting the centers of the positive electrode tab 103 and the negative electrode tab 105) of the negative electrode collector 110. In the direction orthogonal to the center line C, lengths of the plurality of negative electrode reinforcing members 104 monotonically increase or decrease in accordance with the order of arrangement in the laminating direction.

In FIG. 9B, in a case in which the number of laminations of the negative electrode sheets is n, the length of the negative electrode reinforcing member 104 in the direction orthogonal to the center line C, which is a n-th laminated layer from one end side thereof in the laminating direction, is represented as La(n). The negative electrode reinforcing member 104 of the present embodiment is configured such that the length La(n) monotonically increases or decreases from one end side to the other end side in the laminating direction.

In the present embodiment, when viewed from the other end side in the laminating direction, the end portions of all the positive electrode reinforcing members 102 and the negative electrode reinforcing members 104 are in a visible state, and thus all the current-collecting bodies can be welded to the tab by radiating a laser beam only from the other end side. Therefore, in the present embodiment, unlike the second embodiment, it is unnecessary to radiate the laser beam from both ends.

### EXPLANATION OF REFERENCES

100 Secondary battery

101 Laminate

102 Positive electrode reinforcing member

103 Positive electrode tab

103a Positive electrode flat portion

103b Positive electrode protruding portion

105a Negative electrode flat portion

105b Negative electrode protruding portion

104 Negative electrode reinforcing member

105 Negative electrode tab

106 Positive electrode

107 Positive electrode collector

108 Positive electrode mixture

109 Negative electrode

110 Negative electrode collector

111 Negative electrode mixture

112 Separator

113 First solid electrolyte sheet

114 Second solid electrolyte sheet

C Center line

What is claimed is:

1. A secondary battery comprising:
a laminate formed by alternately laminating a positive electrode and a negative electrode via an electrolyte;
on one sidewall side of the laminate,
a positive electrode reinforcing member attached to an end portion of a plate-shaped positive electrode collector which constitutes the positive electrode, and
a positive electrode tab which covers the one sidewall of the laminate and is attached to an end portion of the positive electrode reinforcing member;
on the other sidewall side of the laminate,
a negative electrode reinforcing member attached to an end portion of a plate-shaped negative electrode collector which constitutes the negative electrode, and
a negative electrode tab which covers the other sidewall of the laminate and is attached to an end portion of the negative electrode reinforcing member; and
an outer package which encloses the laminate, the positive electrode reinforcing member, the positive electrode tab, the negative electrode reinforcing member, and the negative electrode tab.

2. The secondary battery according to claim 1,
wherein the laminate is wound a plurality of times around an axis connecting the positive electrode tab and the negative electrode tab,
a plurality of attachment positions of the positive electrode reinforcing member with respect to the positive electrode tab are separated from each other, and
a plurality of attachment positions of the negative electrode reinforcing member with respect to the negative electrode tab are separated from each other.

3. The secondary battery according to claim 1,
wherein the laminate includes a plurality of positive electrodes and a plurality of negative electrodes,
a plurality of attachment positions of the positive electrode reinforcing member with respect to the positive electrode tab are separated from each other, and
a plurality of attachment positions of the negative electrode reinforcing member with respect to the negative electrode tab are separated from each other.

4. The secondary battery according to claim 1,
wherein the positive electrode tab includes a positive electrode flat portion which joins the positive electrode reinforcing member to one main surface thereof, and a positive electrode protruding portion which protrudes from the other main surface of the positive electrode flat portion, and
the negative electrode tab includes a negative electrode flat portion which joins the negative electrode reinforcing member to one main surface thereof, and a negative electrode protruding portion which protrudes from the other main surface of the negative electrode flat portion.

5. The secondary battery according to claim 1,
wherein an angle formed by a main surface of the positive electrode collector and a main surface of the positive electrode tab and an angle formed by a main surface of the negative electrode collector and a main surface of the negative electrode tab is 85 degrees or more and 95 degrees or less, respectively.

6. The secondary battery according to claim 1,
wherein central positions of a plurality of the positive electrode reinforcing members and a plurality of the negative electrode reinforcing members, which are arranged in a laminating direction of the laminate, are separated from a center line connecting centers of the positive electrode tab and the negative electrode tab,
a size of distances between the center line and the central position of the positive electrode reinforcing member monotonically increase or decrease in accordance with the order of arrangement in the laminating direction, and
a size of distances between the center line and the central position of the negative electrode reinforcing member monotonically increase or decrease in accordance with the order of arrangement in the laminating direction.

7. The secondary battery according to claim 1,
wherein a plurality of the positive electrode reinforcing members and a plurality of the negative electrode reinforcing members are arranged in the laminating direction of the laminate, and
lengths of the plurality of positive electrode reinforcing members and lengths of the plurality of negative electrode reinforcing members in a direction orthogonal to the center line connecting the centers of the positive electrode tab and the negative electrode tab monotonically increase or decrease in accordance with the order of arrangement in the laminating direction.

8. The secondary battery according to claim 1, wherein the electrolyte is a solid.

9. The secondary battery according to claim 1, wherein the electrolyte is a liquid.

10. A manufacturing method of the secondary battery according to claim 8, comprising:
attaching the positive electrode reinforcing member and the negative electrode reinforcing member to the positive electrode collector and the negative electrode collector, respectively; and
attaching the positive electrode tab and the negative electrode tab to the positive electrode collector to which the positive electrode reinforcing member is attached and the negative electrode collector to which the negative electrode reinforcing member is attached, respectively.

11. A manufacturing method of the secondary battery according to claim 9, comprising:
attaching the positive electrode reinforcing member and the negative electrode reinforcing member to the positive electrode collector and the negative electrode collector, respectively; and
attaching the positive electrode tab and the negative electrode tab to the positive electrode collector to which the positive electrode reinforcing member is attached and the negative electrode collector to which the negative electrode reinforcing member is attached, respectively.
